(19) United States
(12) Patent Application Publication
(10) Pub. No.: US 2026/0178865 A1
(43) Pub. Date: Jun. 25, 2026

(54) INFORMATION PROCESSING DEVICE

(71) Applicant: NIDEC INSTRUMENTS CORPORATION, Nagano (JP)

(72) Inventor: Teruo MATSUE, Nagano (JP)

(21) Appl. No.: 19/424,122

(22) Filed: Dec. 18, 2025

(30) Foreign Application Priority Data
Dec. 19, 2024 (JP) 2024-223974

(51) Int. Cl. G06K 19/077

(52) U.S. Cl. CPC G06K 19/07701; G06K 19/07749

(57) ABSTRACT

An information processing device which is used for performing data communication with a communication object in a manual operation. The information processing device includes a data communication unit which performs data communication with the communication object, and an accessory unit which is separately formed from the data communication unit and is attached with the data communication unit and is capable of being separated from the data communication unit. The data communication unit includes an interface substrate which is a circuit board for electrically connecting the information processing device to a host apparatus of the information processing device, and the accessory unit includes an electric device which is electrically connected with the interface substrate.

### CROSS REFERENCE TO RELATED APPLICATION

The present invention claims priority under 35 U.S.C. § 119 to Japanese Application No. 2024-223974 filed Dec. 19, 2024, the entire contents of which are incorporated herein by reference.

### FIELD OF THE INVENTION

An embodiment of the present invention may relate to an information processing device.

### BACKGROUND

Conventionally, an information processing device for processing information including secret information has been known (for example, see Japanese Patent Laid-Open No. 2024-164956 (Patent Literature 1)). An information processing device described in Patent Literature 1 is, for example, a settlement terminal which is used at a time of settlement of a price with a credit card or the like. The information processing device includes an IC contact block for communicating with a contact-type IC (Integrated Circuit) card, a communication antenna for communicating with a non-contact type IC card, a housing in which the IC contact block and the antenna are accommodated, and a touch panel for inputting a personal identification number (PIN).

As an international data security standard for safely handling member data of a credit card, for example, the PCI DSS (Payment Card Industry Data Security Standard) has been established. In a case of an information processing device for handling data of a credit card or the like such as an information processing device described in Patent Literature 1, a customer may require to acquire authentication of a security standard such as the PCI DSS for securing safety of the device.

In the case of the PCI DSS, authentication of the PCI DSS is required to acquire for each product and thus, for example, when a function of an information processing device is changed and thereby an outward shape of the information processing device is changed, authentication of the PCI DSS is newly required to acquire for the entire device. On the other hand, in order to acquire authentication of the PCI DSS, for example, an examination of a certification organization is required and thus, a predetermined cost is necessary to acquire the authentication. Therefore, for example, when authentication of the PCI DSS is acquired each time an outward shape of an information processing device is changed depending on a customer's need, expenses for acquisition of the authentication increase.

### SUMMARY

In view of the problem described above, at least an embodiment of the present invention may advantageously provide an information processing device which is required to acquire authentication of a security standard such as PCI DSS. In the information processing device, for example, even when a function of the information processing device is changed and thereby an outward shape of the information processing device is changed, new acquisition of the authentication of the security standard is not required.

According to at least an embodiment of the present invention, there may be provided an information processing device for manually performing data communication with a communication object. The information processing device includes a data communication unit which performs data communication with the communication object, and an accessory unit which is separately formed from the data communication unit and is attached with the data communication unit and is capable of being separated from the data communication unit. The data communication unit includes an interface substrate which is a circuit board for electrically connecting the information processing device to a host apparatus of the information processing device, and the accessory unit includes an electric device which is electrically connected with the interface substrate.

In the information processing device in this embodiment, the data communication unit which performs data communication with a communication object includes an interface substrate which is a circuit board for electrically connecting the information processing device to a host apparatus of the information processing device. Further, in this embodiment, the accessory unit including an electric device electrically connected with the interface substrate is separately formed from the data communication unit and is attached with the data communication unit and is capable of being separated from the data communication unit. Therefore, a function of the information processing device can be changed by changing the accessory unit to which the data communication unit is attached without changing the data communication unit.

Accordingly, in this embodiment, the data communication unit is structured to provide with all functions of the information processing device which are required to acquire authentication of a security standard such as PCI DSS, and the accessory unit has functions of the information processing device which are not required to acquire authentication of the security standard. Therefore, when the data communication unit has acquired authentication of the security standard once, even if the accessory unit attached to the data communication unit is changed, the information processing device after changed is not required to newly acquire the authentication of the security standard. Accordingly, in this embodiment, in an information processing device which is required to acquire authentication of a security standard, for example, even when a function of the information processing device is changed and thereby an outward shape of the information processing device is changed, new acquisition of authentication of the security standard is not required.

### Effects of the Invention

As described above, in accordance with an embodiment of the invention, in an information processing device which is required to acquire authentication of a security standard such as PCI DSS, for example, even when a function of the information processing device is changed and thereby the outward shape of the information processing device is changed, new acquisition of the authentication of a security standard is not required.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view showing an information processing device in accordance with an embodiment of the present invention.

FIG. 2 is a perspective view showing the information processing device in FIG. 1 which is viewed in a different direction.

FIG. 3 is a cross-sectional view showing the information processing device in FIG. 1.

FIG. 4 is a perspective view showing a data communication unit in FIG. 1.

FIG. 5 is a perspective view showing the data communication unit in FIG. 4 which is viewed in a different direction.

FIG. 6 is a cross-sectional view showing the data communication unit in FIG. 4.

FIG. 7 is a perspective view showing an accessory unit in FIG. 1.

FIG. 8 is an exploded perspective view showing the accessory unit in FIG. 7.

### DETAILED DESCRIPTION

An embodiment of the present invention will be described below with reference to the accompanying drawings.

### Schematic Structure of Information Processing Device

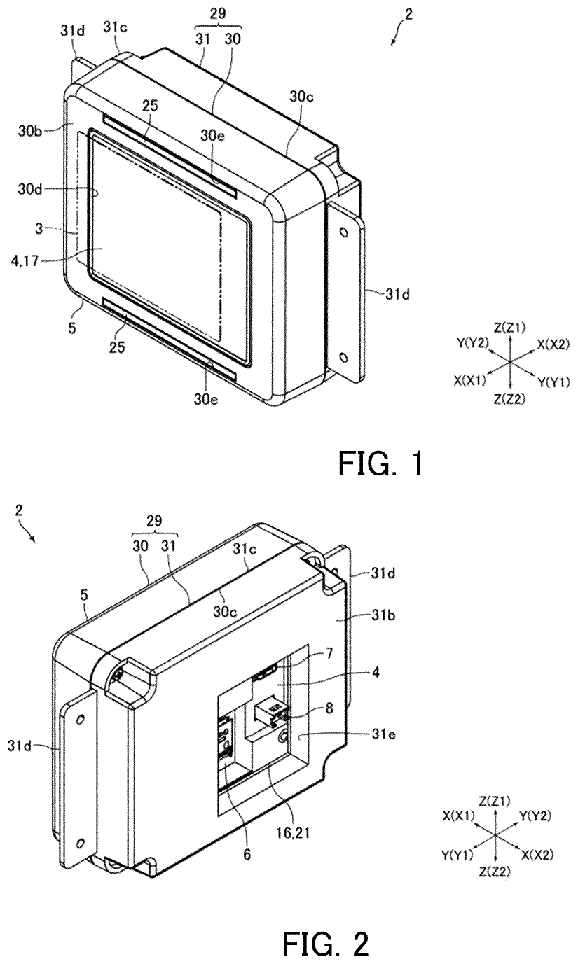

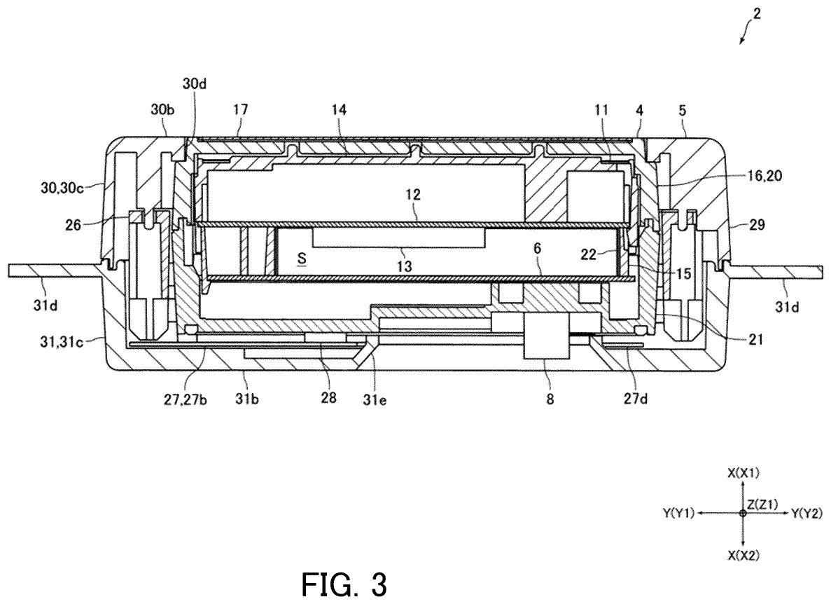

FIG. 1 is a perspective view showing an information processing device 2 in accordance with an embodiment of the present invention. FIG. 2 is a perspective view showing the information processing device 2 in FIG. 1 which is viewed in a different direction. FIG. 3 is a cross-sectional view showing the information processing device 2 in FIG. 1.

In the following descriptions, for convenience of explanation, the Z-direction in FIG. 1 and the like is defined as an upper-lower direction, the X-direction in FIG. 1 and the like which is perpendicular to the upper-lower direction is defined as a front-rear direction, and the Y-direction in FIG. 1 and the like which is perpendicular to the upper-lower direction and the front-rear direction is defined as a left-right direction. Further, the Z1-direction side in FIG. 1 and the like which is one side in the upper-lower direction is referred to as an “upper” side, the Z2-direction side in FIG. 1 and the like which is an opposite side to the upper side is referred to as a “lower” side, the X1-direction side in FIG. 1 and the like which is one side in the front-rear direction is referred to as a “front” side, the X2-direction side in FIG. 1 and the like which is an opposite side to the front side is referred to as a “rear” side, the Y1-direction side in FIG. 1 and the like which is one side in the left-right direction is referred to as a “right” side, and the Y2-direction in FIG. 1 and the like which is an opposite side to the right side is referred to as a “left” side.

The information processing device 2 in this embodiment is a device which is structured to manually perform data communication with a non-contact type IC card 3 (hereinafter, referred to as a “card 3”) which is a communication object. The information processing device 2 is, for example, a settlement terminal which is used at a time of settlement of a price with a credit card and is mounted on a host apparatus of the information processing device 2 for use. For example, the information processing device 2 is mounted on an unmanned or self-service type oil supply apparatus of a gas station for use. Further, the information processing device 2 may be, for example, mounted on an automatic ticketing machine, vending machine, entry-exit management apparatus, ATM (Automatic Teller Machine) for use. An IC chip and a communication antenna electrically connected with the IC chip are built in the card 3. The card 3 is a card in conformity with International Standard and JIS standard.

The information processing device 2 is, as a whole, formed in a substantially rectangular parallelepiped shape whose thickness in the front-rear direction is thin. An outward shape of the information processing device 2 when viewed in the front-rear direction is a substantially rectangular shape whose long side direction is the left-right direction. A user who uses the information processing device 2 puts a card 3 over the information processing device 2 from a front side with respect to the information processing device 2.

The information processing device 2 includes a data communication unit 4 which performs data communication with a card 3 and an accessory unit 5 which is separately formed from the data communication unit 4. The information processing device 2 in this embodiment is structured of the data communication unit 4 and the accessory unit 5. The data communication unit 4 is attached to the accessory unit 5. The data communication unit 4 and the accessory unit 5 are respectively unitized, and the accessory unit 5 is separable from the data communication unit 4. Next, specific structures of the data communication unit 4 and the accessory unit 5 will be described below.

### Structure of Data Communication Unit

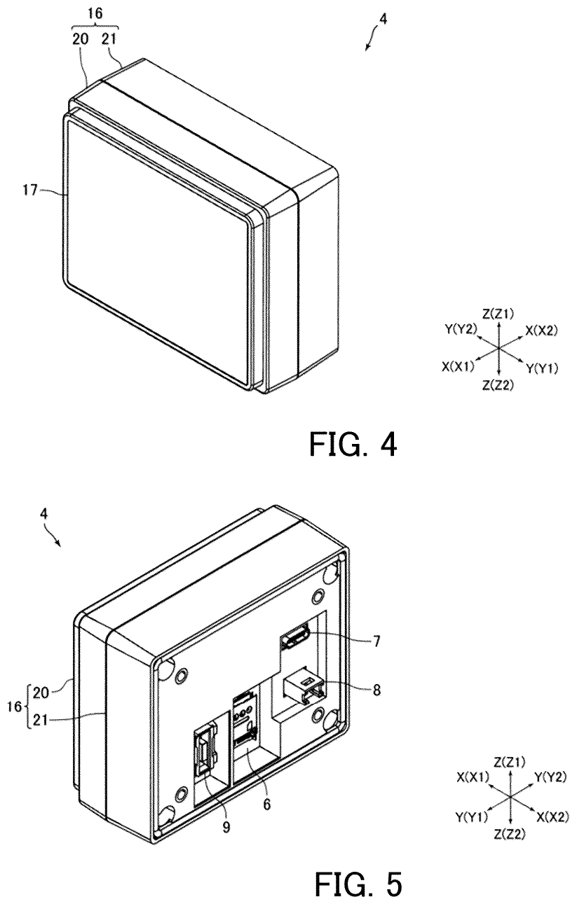

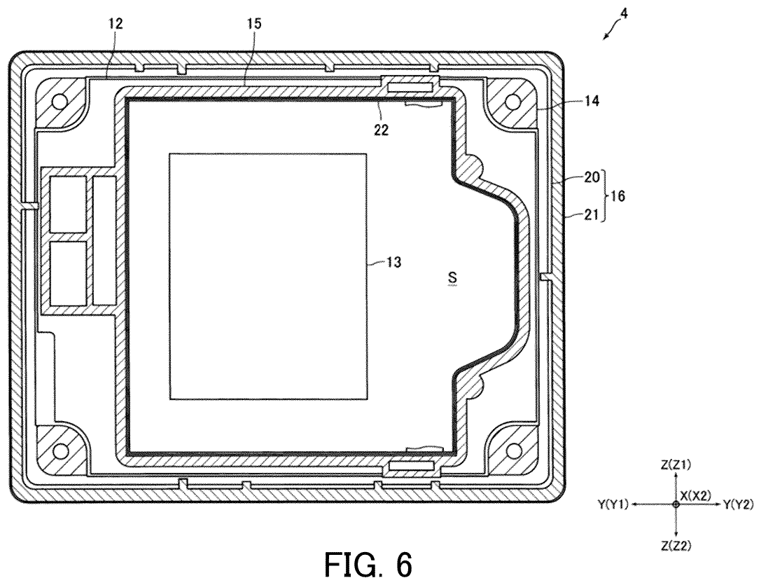

FIG. 4 is a perspective view showing the data communication unit 4 in FIG. 1. FIG. 5 is a perspective view showing the data communication unit 4 in FIG. 4 which is viewed in a different direction. FIG. 6 is a cross-sectional view showing the data communication unit 4 in FIG. 4.

The data communication unit 4 is formed in a rectangular parallelepiped shape. An outward shape of the data communication unit 4 when viewed in the front-rear direction is a rectangular shape whose long side direction is the left-right direction. A front face of the data communication unit 4 is a flat face perpendicular to the front-rear direction. The data communication unit 4 includes a circuit board 6 for electrically connecting the information processing device 2 to a host apparatus, and three connectors 7 through 9 mounted on the circuit board 6. The circuit board 6 in this embodiment is an interface substrate.

Further, the data communication unit 4 includes a communication antenna 11 (see FIG. 3) for communicating with a card 3 in a non-contact manner, a circuit board 12 connected with the antenna 11, an electronic component 13 mounted on the circuit board 12, a first frame 14 to which the antenna 11 is attached, a second frame 15 which holds the circuit boards 6 and 12, a housing 16 which accommodates the circuit boards 6 and 12, antenna 11, electronic component 13, first frame 14 and second frame 15, and a front face panel 17 which structures a front face of the data communication unit 4. The circuit board 12 in this embodiment is a data communication substrate, and the housing 16 is a communication unit housing.

As described above, the data communication unit 4 is formed in a rectangular parallelepiped shape, and the housing 16 is formed in a hollow rectangular parallelepiped shape. The housing 16 is structured of a first housing member 20 and a second housing member 21 which are divided in the front-rear direction. The first housing member 20 structures a front side portion of the housing 16, and the second housing member 21 structures a rear side portion of the housing 16. The first housing member 20 and the second housing member 21 are formed in a flat rectangular box shape whose thickness in the front-rear direction is thin. Further, the first housing member 20 is formed in a rectangular parallelepiped box shape whose rear face side is opened, and the second housing member 21 is formed in a rectangular parallelepiped box shape whose front face side is opened. A rear face part of the second housing member 21 is formed with opening parts for exposing the connectors 7 through 9 outside the housing 16.

The front face panel 17 is attached to a front face of the housing 16. Specifically, the front face panel 17 is attached to a front face of the first housing member 20. The first frame 14 is disposed on an inner side of the first housing member 20. The antenna 11 is wound around in a rectangular ring shape. The antenna 11 is fixed to a front face of the first frame 14. The antenna 11 is disposed on a rear side with respect to a front face part of the first housing member 20. In other words, the antenna 11 is disposed on a rear side with respect to the front face panel 17. The front face panel 17 is indicated with a predetermined mark for showing a center position of the antenna 11. The mark is, for example, a logo mark (ripple mark) prescribed in EMV which is International Standard.

The second frame 15 is formed in a substantially rectangular tube shape whose length in the front-rear direction is short. The circuit boards 6 and 12 are rigid substrates such as a glass epoxy substrate. The circuit boards 6 and 12 are formed in a substantially rectangular flat plate shape. A thickness direction of the circuit board 6 is coincided with the front-rear direction, and a thickness direction of the circuit board 12 is coincided with the front-rear direction. The circuit board 6 is attached to a front end part of the second frame 15. The circuit board 12 is attached to a rear end part of the second frame 15. The circuit boards 6 and 12 and the second frame 15 are disposed on a rear side with respect to the first frame 14.

The electronic component 13 is a component for processing a signal inputted from the antenna 11. The electronic component 13 is mounted on a rear face of the circuit board 12. The antenna 11 is connected to a rear face of the circuit board 12. The connectors 7 and 8 are interface connectors for electrically connecting the circuit board 6 to a host apparatus. The connector 9 is a connector for electrically connecting the circuit board 6 with the accessory unit 5. The connectors 7 through 9 are mounted on a rear face of the circuit board 6. Specifically, the connectors 7 and 8 are mounted on a left side portion of the rear face of the circuit board 6, and the connector 9 is mounted on a right side portion of the rear face of the circuit board 6. Connection ports of the connectors 7 through 9 face the rear side. The connector 9 in this embodiment is a data communication unit side connector.

A flexible printed board 22 (hereinafter, referred to as an “FPC 22”) is disposed on an inner peripheral side of the second frame 15 which is formed in a tube shape. In other words, the data communication unit 4 includes the FPC 22. The FPC 22 is extended in a ring shape along the inner peripheral face of the second frame 15. A thickness direction of the FPC 22 is perpendicular to the upper-lower direction. The FPC 22 is disposed between the circuit board 6 and the circuit board 12 in the front-rear direction. The electronic component 13 is disposed on an inner peripheral side with respect to the FPC 22. The FPC 22 is connected with a rear face of the circuit board 12.

The FPC 22 is formed with a detection circuit for detecting at least one of its own disconnection and short-circuit. The detection circuit is formed in the entire area of the FPC 22. A rear face of the circuit board 6 and a front face of the circuit board 12 are also formed with detection circuits for detecting at least one of its own disconnection and short-circuit. The detection circuit is, for example, formed in the entire areas of the circuit boards 6 and 12. An area defined by the circuit boards 6 and 12 and the FPC 22 is formed as a protection area “S” which is surrounded by the detection circuits from all directions. The protection area “S” is an area where security is secured.

### Structure of Accessory Unit

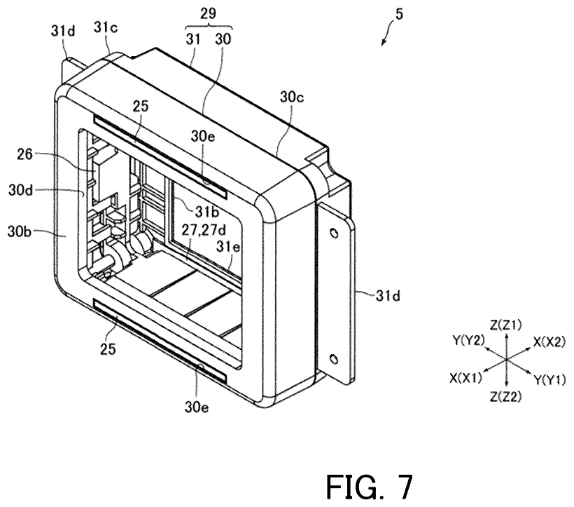

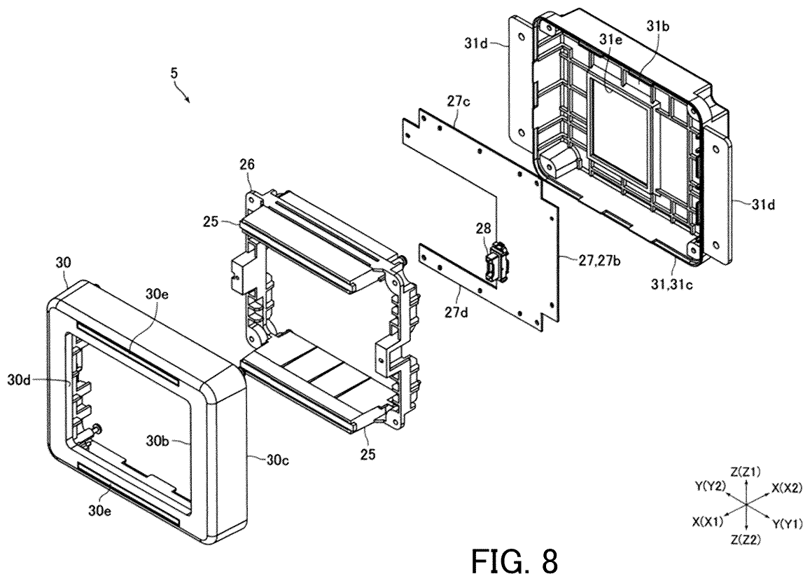

FIG. 7 is a perspective view showing the accessory unit 5 in FIG. 1. FIG. 8 is an exploded perspective view showing the accessory unit 5 in FIG. 7.

An outward shape of the accessory unit 5 is a substantially rectangular parallelepiped shape whose thickness in the front-rear direction is thin. An outward shape of the accessory unit 5 when viewed in the front-rear direction is a substantially rectangular shape whose long side direction is the left-right direction. The accessory unit 5 includes electric devices 25 electrically connected to the circuit board 6. The electric device 25 is, for example, a lighting device, speaker, display or camera for reading a two-dimensional code or the like. The accessory unit 5 includes one or a plurality of kinds of electric devices 25.

For example, the accessory unit 5 includes a lighting device as the electric device 25 and includes one kind of electric device 25. Further, for example, the accessory unit 5 includes a lighting device and a speaker as the electric device 25 and includes two kinds of electric devices 25. In the following descriptions, an embodiment where the accessory unit 5 includes only a lighting device as the electric device 25 will be described below. In the following descriptions, the electric device 25 is a “lighting device 25” as an example. In the present specification, an “electric device” is a device operated by electricity, and the electric device also includes an electronic device to which an electronic technique is applied.

The accessory unit 5 includes two lighting devices 25. Further, the accessory unit 5 includes a frame 26 which holds the two lighting devices 25, a circuit board 27 with which the lighting devices 25 are electrically connected, a connector 28 which is mounted on the circuit board 27, and a housing 29 in which the lighting devices 25, frame 26, circuit board 27 and connector 28 are accommodated. The circuit board 27 in this embodiment is an accessory unit board, and the connector 28 is an accessory unit side connector. Further, the housing 29 in this embodiment is an accessory unit housing.

The housing 29 includes a first housing member 30 and a second housing member 31 which are divided in the front-rear direction. The housing 29 in this embodiment is structured of the first housing member 30 and the second housing member 31. The first housing member 30 structures a front side portion of the housing 29, and the second housing member 31 structures a rear side portion of the housing 29. The first housing member 30 is structured of a front face part 30b in a rectangular frame shape structuring a front face of the first housing member 30 and a tube part 30c in a rectangular tube shape which is connected with an outer peripheral face of the front face part 30b. The tube part 30c is extended toward a rear side from the front face part 30b. A length in the front-rear direction of the tube part 30c is short.

An inner peripheral side of the front face part 30b is formed with an opening part 30d for exposing the front face panel 17 outside the housing 29. In other words, the first housing member 30 is formed with the opening part 30d. The opening part 30d is formed in a rectangular shape whose long side direction is the left-right direction. A front end part of the data communication unit 4 is disposed in the opening part 30d. Specifically, the front end part of the first housing member 20 and the front face panel 17 are disposed in the opening part 30d. The front end of the data communication unit 4 is disposed at a substantially same position as the front face of the front face part 30b in the front-rear direction.

The front face part 30b is formed with an opening part 30e for exposing a light irradiation part of the lighting device 25 outside the housing 29. The opening part 30e is formed at two positions on an upper side and a lower side with respect to the opening part 30d. The opening part 30e is formed in a rectangular shape which is long and thin in the left-right direction. The tube part 30c is disposed on an outer peripheral side with respect to the data communication unit 4. Specifically, the tube part 30c is disposed on an outer peripheral side with respect to a front side portion of the data communication unit 4.

The second housing member 31 is structured of a rear face part 31b in a rectangular shape which structures a rear face of the second housing member 31, a tube part 31c in a rectangular tube shape which is connected with an outer peripheral face of the rear face part 31b, and two fixed parts 31d which are fixed to a host apparatus. The tube part 31c is extended toward a front side from the rear face part 31b. A length in the front-rear direction of the tube part 31c is short. The rear face part 31b is disposed on a rear side with respect to the data communication unit 4. The tube part 31c is disposed on an outer peripheral side with respect to the data communication unit 4. Specifically, the tube part 31c is disposed on an outer peripheral side with respect to a rear side portion of the data communication unit 4. The first housing member 30 and the second housing member 31 are fixed to each other in a state that a rear end of the tube part 30c and a front end of the tube part 31c are in contact with each other.

The rear face part 31b is formed with an opening part 31e for exposing the connectors 7 and 8 outside the housing 29. The opening part 31e is formed in a rectangular shape whose long side direction is the upper-lower direction. The fixed part 31d is formed in a flat plate shape whose thickness direction is the front-rear direction. Further, the fixed part 31d is formed in a rectangular shape whose long side direction is the upper-lower direction. The fixed part 31d is connected with a front end part of the tube part 31c. The fixed part 31d is enlarged toward an outer side in the left-right direction from a front end part of the tube part 31c. In this embodiment, the fixed parts 31d are fixed to a host apparatus and thereby, the information processing device 2 is fixed to the host apparatus.

The lighting device 25 is, for example, an LED lighting device which includes a plurality of LED (Light Emitting Diode) light sources and an optical element such as a diffusion plate. The frame 26 is formed in a rectangular frame shape whose long side direction is the left-right direction. The frame 26 is disposed on an inner side with respect to the first housing member 30 and is disposed on a rear side with respect to the front face part 30b of the first housing member 30. The frame 26 is fixed to the front face part 30b. The lighting device 25 is attached to an upper side part and a lower side part, i.e., at two positions, of the frame 26, and is disposed at two positions, i.e., in an upper end part and a lower end part of the accessory unit 5. A front end part of the lighting device 25 is disposed inside the opening part 30e of the first housing member 30. A front face of the lighting device 25 is a light irradiation part.

The circuit board 27 is a rigid substrate such as a glass epoxy substrate. A thickness direction of the circuit board 27 is coincided with the front-rear direction. The circuit board 27 is structured of a first board part 27b in a rectangular shape which structures a right side portion of the circuit board 27, a second board part 27c in a rectangular shape extended toward a left side from an upper end side of the first board part 27b, and a third board part 27d in a rectangular shape extended toward a left side from a lower end side of the first board part 27b.

The circuit board 27 is attached to a rear end part of the frame 26. The circuit board 27 is disposed on a front side with respect to the rear face part 31b of the second housing member 31. Further, the circuit board 27 is disposed on a rear side with respect to the data communication unit 4. The first board part 27b is disposed on a right side with respect to a right end of the opening part 31e of the second housing member 31. The second board part 27c is disposed on an upper side with respect to an upper end of the opening part 31e. The third board part 27d is disposed on a lower side with respect to a lower end of the opening part 31e.

A rear end part of the lighting device 25 is mounted on a front face of the circuit board 27. Specifically, one of the two lighting devices 25 is mounted on a front face of the second board part 27c, and the other of the lighting devices 25 is mounted on a front face of the third board part 27d. The connector 28 is a connector for connecting the circuit board 6 with the circuit board 27. The connector 28 is mounted on a front face of the circuit board 27. Specifically, the connector 28 is mounted on a left end side of a front face of the first board part 27b. A connection port of the connector 28 faces the front side. The connector 9 is capable of connecting with the connector 28 from the front side.

As described above, a front end part of the data communication unit 4 is disposed inside the opening part 30d, the rear face part 31b is disposed on a rear side with respect to the data communication unit 4, and the tube parts 30c and 31c are disposed on an outer peripheral side with respect to the data communication unit 4. In other words, as shown in FIG. 3, the data communication unit 4 is accommodated in the housing 29. Specifically, the entire data communication unit 4 is accommodated in the housing 29. Further, the tube parts 30c and 31c are disposed on an outer peripheral side with respect to the data communication unit 4, and the housing 29 covers a side face of the data communication unit 4 over its entire circumference. Further, as described above, the lighting devices 25, frame 26, circuit board 27 and connector 28 are accommodated in the housing 29. In other words, the components of the accessory unit 5 is accommodated in the housing 29.

The first housing member 30 and the second housing member 31 are fixed to each other in a state that a part of the data communication unit 4 is sandwiched between the first housing member 30 and the second housing member 31. When the first housing member 30 and the second housing member 31 are fixed to each other in a state that a part of the data communication unit 4 is sandwiched, the data communication unit 4 is accommodated in the housing 29 and the data communication unit 4 is attached to the accessory unit 5. Further, when the first housing member 30 and the second housing member 31 are fixed to each other in a state that a part of the data communication unit 4 is sandwiched, the connector 9 and the connector 28 are connected with each other. In other words, when the data communication unit 4 is accommodated in the housing 29, the connector 9 and the connector 28 are connected with each other.

### Structure of Information Processing Device

As described above, the data communication unit 4 is accommodated in the housing 29. In other words, the data communication unit 4 is built in the accessory unit 5. The connectors 7 and 8 which are disposed in an opening part of the rear face part of the second housing member 21 and the opening part 31e are exposed in a rear face of the information processing device 2. Wiring drawn out from a host apparatus is connected to the connectors 7 and 8. Specifically, connectors attached to tip ends of wiring lines are connected to the connectors 7 and 8.

In the front face of the information processing device 2, the front face panel 17 is disposed in an inside of the opening part 30d. When the information processing device 2 is to perform data communication with a card 3 in a non-contact manner, a user puts the card 3 over the front face panel 17 from a front side with respect to the information processing device 2. The light irradiation part of the lighting device 25 is disposed on both sides in the upper-lower direction with respect to the front face panel 17. The lighting devices 25 function to guide a user so that the user puts a card 3 over the front face panel 17.

In this embodiment, the data communication unit 4 is provided with a function for performing data communication with a card 3. On the other hand, the accessory unit 5 is, for example, provided with only a lighting function. In other words, in this embodiment, the data communication unit 4 includes all functions of the information processing device 2 which are required to acquire authentication of a security standard such as PCI DSS. On the other hand, the accessory unit 5 has a function of the information processing device 2 which is not required to acquire authentication of the security standard.

### Principal Effects in This Embodiment

As described above, in this embodiment, the data communication unit 4 which performs data communication with a card 3 includes the circuit board 6 for electrically connecting the information processing device 2 to a host apparatus. Further, in this embodiment, the accessory unit 5 including the electric device 25 which is electrically connected to the circuit board 6 is separately formed from the data communication unit 4 and is attached with the data communication unit 4 and is capable of being separated from the data communication unit 4. Therefore, when the accessory unit 5 to which the data communication unit 4 is attached is changed, functions of the information processing device 2 can be changed without changing the data communication unit 4.

Further, in this embodiment, the data communication unit 4 has all functions of the information processing device 2 which are required to acquire authentication of a security standard such as PCI DSS and, on the other hand, the accessory unit 5 has a function of the information processing device 2 which is not required to acquire authentication of the security standard. Therefore, according to this embodiment, when the data communication unit 4 has acquired authentication of the security standard once, even if the accessory unit 5 attached to the data communication unit 4 is changed, the information processing device 2 after changed is not required to newly acquire the authentication of the security standard. Accordingly, in this embodiment, in an information processing device 2 which is required to acquire authentication of a security standard, even when a function of the information processing device 2 is, for example, changed and thereby an outward shape of the information processing device 2 is changed, new acquisition of authentication of the security standard is not required.

In this embodiment, the data communication unit 4 includes the housing 16 in which the circuit boards 6 and 12, the antenna 11, the electronic component 13, the first frame 14 and the second frame 15 are accommodated. Therefore, according to this embodiment, the data communication unit 4 before attached to the accessory unit 5 can be easily handled as the housing 16. Further, in this embodiment, the accessory unit 5 includes the housing 29 in which the data communication unit 4 is accommodated and a component of the accessory unit 5 is accommodated and thus, the information processing device 2 can be easily handled as the housing 29.

In this embodiment, when the data communication unit 4 is accommodated in the housing 29, the connector 9 of the data communication unit 4 and the connector 28 of the accessory unit 5 are connected with each other. In other words, according to this embodiment, the circuit board 6 of the data communication unit 4 and the electric device 25 are electrically connected with each other by simply accommodating the data communication unit 4 in the housing 29. Therefore, in this embodiment, an electrical connecting operation between the circuit board 6 and the electric device 25 can be easily performed. Especially, in this embodiment, the first housing member 30 and the second housing member 31 are fixed to each other in a state that a part of the data communication unit 4 is sandwiched and thereby, the connector 9 and the connector 28 are connected with each other and the circuit board 6 and the electric device 25 are electrically connected with each other. Therefore, an electrical connecting operation between the circuit board 6 and the electric device 25 can be further easily performed.

### Other Embodiments

Although the present invention has been shown and described with reference to a specific embodiment, various changes and modifications will be apparent to those skilled in the art from the teachings herein.

In the embodiment described above, the first housing member 30 and the second housing member 31 may be fixed to each other in a state that the entire data communication unit 4 is sandwiched between the first housing member 30 and the second housing member 31. Further, in the embodiment described above, a part of the data communication unit 4 is not required to be accommodated in the housing 29. Further, the entire data communication unit 4 is not required to be accommodated in the housing 29. In this case, for example, the data communication unit 4 is attached to a front side of the accessory unit 5. In addition, in the embodiment described above, the housing 29 is not required to cover a side face of the data communication unit 4 over its entire circumference. Further, in the embodiment described above, the accessory unit 5 is not required to include the housing 29.

In the embodiment described above, in a case that a magnetic card reader which performs at least one of reading of magnetic data recorded in a magnetic card and recording of magnetic data to a magnetic card or an IC card leader which performs data communication with a contact-type IC card do not require authentication of the security standard, the electric device 25 may be the magnetic card reader or the IC card reader. Further, the electric device 25 may be a touch key for inputting a secret code number or a personal identification number.

In the embodiment described above, the data communication unit 4 may include an IC contact block having a plurality of IC contact springs for performing data communication with a contact-type IC card. In this case, the data communication unit 4 may include no antenna 11. In other words, in the embodiment described above, a communication object is a contact-type IC card, and the information processing device 2 may be a device for performing data communication with a contact-type IC card in a manual manner. Further, the data communication unit 4 may include a magnetic head for performing reading of magnetic data recorded in a magnetic card and recording of magnetic data to a magnetic card. Further, the data communication unit 4 may include a camera for reading a two-dimensional code and the like and a touch key for inputting a secret code number and a personal identification number.

In the embodiment described above, the circuit board 6 and the circuit board 27 may be connected with each other through wiring lines. Further, in the embodiment described above, the accessory unit 5 may include no circuit board 27. In this case, the electric device 25 is connected with the circuit board 6 through wiring lines. In addition, in the embodiment described above, the front face panel 17 may be a display such as a liquid crystal display. In this case, the front face panel 17 may be a display with a touch panel. Further, in the embodiment described above, a communication object which performs data communication with the information processing device 2 may be an information recording medium other than a card 3, or may be an electronic device such as a smartphone or an RFID tag.

### Technical Structure

Embodiments of the present invention may be structured as follows.
(1) An information processing device for performing data communication with a communication object in a manual operation, the information processing device including a data communication unit which performs data communication with the communication object, and an accessory unit which is separately formed from the data communication unit and is attached with the data communication unit and is capable of being separated from the data communication unit, where the data communication unit includes an interface substrate which is a circuit board for electrically connecting the information processing device to a host apparatus of the information processing device, and the accessory unit includes an electric device which is electrically connected with the interface substrate.
(2) The information processing device described in the above-mentioned structure (1), where the communication object is a non-contact type IC card and the data communication unit includes a communication antenna for communicating with the IC card in a non-contact manner.
(3) The information processing device described in the above-mentioned structure (2), where the data communication unit includes a data communication substrate which is a circuit board connected with the antenna, and a communication unit housing which is a housing in which the interface substrate, the data communication substrate and the antenna are accommodated.
(4) The information processing device described in one of the above-mentioned structures (1) through (3), where the electric device is a lighting device, a speaker, a camera or a display, and the accessory unit includes one or a plurality of kinds of the electric devices.
(5) The information processing device described in one of the above-mentioned structures (1) through (4), where the accessory unit includes an accessory unit housing which is a housing in which at least a part of the data communication unit is accommodated and a component of the accessory unit is accommodated.
(6) The information processing device described in the above-mentioned structure (5), where the data communication unit is formed in a rectangular parallelepiped shape, and the accessory unit housing covers a side face of the data communication unit over its entire circumference.
(7) The information processing device described in the above-mentioned structure (5) or (6), where the data communication unit includes a data communication unit side connector which is a connector mounted on the interface substrate, the accessory unit includes an accessory unit substrate which is a circuit board electrically connected with the electric device, and an accessory unit side connector which a connector mounted on the accessory unit substrate and, when at least a part of the data communication unit is accommodated in the accessory unit housing, the data communication unit side connector and the accessory unit side connector are connected with each other.
(8) The information processing device described in the above-mentioned structure (7), where the accessory unit housing includes a first housing member and a second housing member which are fixed to each other in a state that at least a part of the data communication unit is sandwiched and, when the first housing member and the second housing member are fixed to each other in the state that at least a part of the data communication unit is sandwiched, the data communication unit side connector and the accessory unit side connector are connected with each other.

In the structures described above, for example, the communication object is a non-contact type IC card and the data communication unit includes a communication antenna for communicating with the IC card in a non-contact manner.

In the structure described above, for example, the data communication unit includes a data communication substrate which is a circuit board connected with the antenna, and a communication unit housing which is a housing in which the interface substrate, the data communication substrate and the antenna are accommodated. In this case, the interface substrate, the data communication substrate and the antenna are accommodated in the communication unit housing and thus, the data communication unit before attached to the accessory unit can be easily handled as one communication unit housing.

In the structure described above, for example, the electric device is a lighting device, a speaker, a camera or a display, and the accessory unit includes one or a plurality of kinds of the electric devices.

In the structure described above, it is preferable that the accessory unit includes an accessory unit housing which is a housing in which at least a part of the data communication unit is accommodated and a component of the accessory unit is accommodated. According to this structure, at least a part of the data communication unit and a component of the accessory unit are accommodated in the accessory unit housing and thus, the information processing device can be easily handled as one accessory unit housing.

In the structure described above, for example, the data communication unit is formed in a rectangular parallelepiped shape and the accessory unit housing covers a side face of the data communication unit over its entire circumference.

In the structure described above, it is preferable that the data communication unit includes a data communication unit side connector which is a connector mounted on the interface substrate, the accessory unit includes an accessory unit substrate which is a circuit board electrically connected with the electric device and an accessory unit side connector which a connector mounted on the accessory unit substrate and, when at least a part of the data communication unit is accommodated in the accessory unit housing, the data communication unit side connector and the accessory unit side connector are connected with each other. According to this structure, the interface substrate and the electric device can be electrically connected with each other simply by accommodating at least a part of the data communication unit in the accessory unit housing. Therefore, an electrical connecting operation between the interface substrate and the electric device can be easily performed.

In the structure described above, it is preferable that the accessory unit housing includes a first housing member and a second housing member which are fixed to each other in a state that at least a part of the data communication unit is sandwiched and, when the first housing member and the second housing member are fixed to each other in the state that at least a part of the data communication unit is sandwiched, the data communication unit side connector and the accessory unit side connector are connected with each other. According to this structure, the interface substrate and the electric device can be electrically connected with each other by fixing the first housing member to the second housing member in a state that at least a part of the data communication unit is sandwiched and thus, the electrical connecting operation between the interface substrate and the electric device can be further easily performed.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An information processing device which is used for performing data communication with a communication object in a manual operation, the information processing device comprising:
a data communication unit which performs data communication with the communication object; and
an accessory unit which is separately formed from the data communication unit and is attached with the data communication unit and is capable of being separated from the data communication unit;
wherein the data communication unit comprises an interface substrate which is a circuit board for electrically connecting the information processing device to a host apparatus of the information processing device; and
the accessory unit comprises an electric device which is electrically connected with the interface substrate.

2. The information processing device according to claim 1, wherein
the communication object is a non-contact type IC card, and
the data communication unit comprises a communication antenna for communicating with the IC card in a non-contact manner.

3. The information processing device according to claim 2, wherein the data communication unit comprises a data communication substrate which is a circuit board connected with the antenna, and a communication unit housing which is a housing in which the interface substrate, the data communication substrate and the antenna are accommodated.

4. The information processing device according to claim 1, wherein
the electric device is a lighting device, a speaker, a camera or a display, and
the accessory unit comprises one or a plurality of kinds of the electric devices.

5. The information processing device according to claim 1, wherein the accessory unit comprises an accessory unit housing which is a housing in which at least a part of the data communication unit is accommodated and a component of the accessory unit is accommodated.

6. The information processing device according to claim 5, wherein
the data communication unit is formed in a rectangular parallelepiped shape, and
the accessory unit housing covers over an entire circumference of a side face of the data communication unit.

7. The information processing device according to claim 5, wherein
the data communication unit comprises a data communication unit side connector which is a connector mounted on the interface substrate,
the accessory unit comprises an accessory unit substrate which is a circuit board electrically connected with the electric device, and an accessory unit side connector which is a connector mounted on the accessory unit substrate, and
when at least a part of the data communication unit is accommodated in the accessory unit housing, the data communication unit side connector and the accessory unit side connector are connected with each other.

8. The information processing device according to claim 7, wherein
the accessory unit housing comprises a first housing member and a second housing member which are fixed to each other in a state that at least a part of the data communication unit is sandwiched, and
when the first housing member and the second housing member are fixed to each other in the state that at least a part of the data communication unit is sandwiched, the data communication unit side connector and the accessory unit side connector are connected with each other.

9. The information processing device according to claim 2, wherein the accessory unit comprises an accessory unit housing which is a housing in which at least a part of the data communication unit is accommodated and a component of the accessory unit is accommodated.

10. The information processing device according to claim 9, wherein
the data communication unit is formed in a rectangular parallelepiped shape, and
the accessory unit housing covers over an entire circumference of a side face of the data communication unit.

11. The information processing device according to claim 9, wherein
the data communication unit comprises a data communication unit side connector which is a connector mounted on the interface substrate,
the accessory unit comprises an accessory unit substrate which is a circuit board electrically connected with the electric device, and an accessory unit side connector which is a connector mounted on the accessory unit substrate, and
when at least a part of the data communication unit is accommodated in the accessory unit housing, the data communication unit side connector and the accessory unit side connector are connected with each other.

12. The information processing device according to claim 11, wherein
the accessory unit housing comprises a first housing member and a second housing member which are fixed to each other in a state that at least a part of the data communication unit is sandwiched, and
when the first housing member and the second housing member are fixed to each other in the state that at least a part of the data communication unit is sandwiched, the data communication unit side connector and the accessory unit side connector are connected with each other.

13. The information processing device according to claim 3, wherein the accessory unit comprises an accessory unit housing which is a housing in which at least a part of the data communication unit is accommodated and a component of the accessory unit is accommodated.

14. The information processing device according to claim 13, wherein
the data communication unit is formed in a rectangular parallelepiped shape, and
the accessory unit housing covers over an entire circumference of a side face of the data communication unit.

15. The information processing device according to claim 13, wherein
the data communication unit comprises a data communication unit side connector which is a connector mounted on the interface substrate,
the accessory unit comprises an accessory unit substrate which is a circuit board electrically connected with the electric device, and an accessory unit side connector which is a connector mounted on the accessory unit substrate, and
when at least a part of the data communication unit is accommodated in the accessory unit housing, the data communication unit side connector and the accessory unit side connector are connected with each other.

16. The information processing device according to claim 15, wherein
the accessory unit housing comprises a first housing member and a second housing member which are fixed to each other in a state that at least a part of the data communication unit is sandwiched, and
when the first housing member and the second housing member are fixed to each other in the state that at least a part of the data communication unit is sandwiched, the data communication unit side connector and the accessory unit side connector are connected with each other.

17. The information processing device according to claim 4, wherein the accessory unit comprises an accessory unit housing which is a housing in which at least a part of the data communication unit is accommodated and a component of the accessory unit is accommodated.

18. The information processing device according to claim 17, wherein
the data communication unit is formed in a rectangular parallelepiped shape, and
the accessory unit housing covers over an entire circumference of a side face of the data communication unit.

19. The information processing device according to claim 17, wherein
the data communication unit comprises a data communication unit side connector which is a connector mounted on the interface substrate,
the accessory unit comprises an accessory unit substrate which is a circuit board electrically connected with the electric device, and an accessory unit side connector which is a connector mounted on the accessory unit substrate, and
when at least a part of the data communication unit is accommodated in the accessory unit housing, the data communication unit side connector and the accessory unit side connector are connected with each other.

20. The information processing device according to claim 19, wherein
the accessory unit housing comprises a first housing member and a second housing member which are fixed to each other in a state that at least a part of the data communication unit is sandwiched, and
when the first housing member and the second housing member are fixed to each other in the state that at least a part of the data communication unit is sandwiched, the data communication unit side connector and the accessory unit side connector are connected with each other.
